(19) United States
(12) Patent Application Publication
(10) Pub. No.: US 2020/0184116 A1
(43) Pub. Date: Jun. 11, 2020

(54) COMPUTER LOCK SYSTEM

(71) Applicant: Kenichi Ishihara, Kanagawa (JP)

(72) Inventor: Kenichi Ishihara, Kanagawa (JP)

(21) Appl. No.: 16/658,959

(22) Filed: Oct. 21, 2019

Related U.S. Application Data
(63) Continuation of application No. PCT/JP2018/000880, filed on Jan. 15, 2018.

(30) Foreign Application Priority Data
Apr. 19, 2017 (JP) 2017-083191

(51) Int. Cl. G06F 21/84; G06F 21/35

(52) U.S. Cl. CPC G06F 21/84; G06F 21/35

(57) ABSTRACT

A computer lock system comprising a computer body and a wireless receiver connected thereto is provided. The wireless receiver includes: a wireless signal receiving unit that receives a wireless signal that may include noise or be in a no-signal state; and a received signal outputting unit that outputs the received wireless signal to the computer body. The computer body includes: a received signal acquisition unit that acquires the signal output from the received signal outputting unit; an ID determination unit that determines, in an intermittent manner, whether an unlock ID, which is an ID for enabling usual access to a display interface of the computer body, is contained in an acquired signal from the received signal acquisition unit; an accessible status information holding unit that holds accessible status information that indicates whether or not the usual access to the display interface of the computer body is enabled, the indication being determined based on the acquired signal; an access-enabling unit that changes, when the ID determination unit determines that a valid unlock ID is contained, the accessible status information held in the accessible status information holding unit to an accessible status for enabling the usual access to the display interface of the computer body; an access-disabling unit that changes, when the ID determination unit determines that a valid unlock ID is not contained, the accessible status information held in the accessible status information holding unit to an inaccessible status for causing the display interface of the computer body to disable the usual access to a display; and a control unit that controls the display interface based on the accessible status information held in the accessible status information holding unit.

This application is a continuation application of PCT Application No. PCT/JP2018/000880 filed on Jan. 15, 2018, claiming the benefit of priority to Japanese Patent Application No. 2017-831919 filed on Apr. 19, 2017, each of which is incorporated herein by reference.

### FIELD OF THE INVENTION

The present invention relates to a computer lock system and, in particular, to a computer lock system that is implemented by a computer body and a wireless communication device connected to the computer body.

### BACKGROUND ART

There are conventionally known methods or apparatuses for controlling processing devices that disable data input from keyboards or mice when specific users temporarily leave from their seats partway through working on computers. Japanese Patent Publication No. 2001-268655 (Patent Document 1) may be provided as an example of this, and Patent Document 1 discloses a configuration that includes a computer with an antenna, a personal digital assistant (PDA), a mouse and the like, and in which communication with the PDA is established via the antenna connected to a near-field communication interface embedded in the computer. When a specific user moves away from the computer while holding the PDA and the communication is therefore rendered unavailable, data input from a keyboard, a mouse or the like is disabled. When the specific user returns to his/her seat while holding the PDA, the disabling is automatically cancelled, and the computer is restored to the usable state.

Japanese Patent Publication No. 2000-222059 (Patent Document 2) may be provided as another example, and Patent Document 2 discloses an information processing device configured by a portable wireless tag (an RFID card, etc.) and a POS body with an antenna and having a configuration that prevents unauthorized operations by prohibiting data input when a qualified user moves away from the POS body without performing processing for terminating or suspending operations and by allowing the data input when the user approaches the POS body.

### PRIOR ART REFERENCES

### Patent Documents

Patent Document 1: Japanese Patent Publication No. 2001-268655

Patent Document 2: Japanese Patent Publication No. 2000-222059

Patent Document 3: Japanese Patent Publication No. H06-259160

### SUMMARY OF THE INVENTION

### Problems to be Solved by the Invention

These security systems, however, also have their own weaknesses. For example, when part of a security system is made to freeze without the computer being locked, the computer may be fixed in such frozen state and may be illegally used despite an appropriate unlock wireless signal not being reached.

Such frozen state may be rendered by, for example, an attack being conducted on programs. Alternatively, it is also possible to disable antenna functions to render the frozen state. For example, antennae may be disconnected. The reason for this is that, if signals from the antennae are lost, there is no way to determine whether the source to transmit appropriate unlock wireless signals is out of communication range or whether it is within the communication range but has lost its wireless function. The reason for this is that, while such determination is made based on the signals from the antennae, the signals from the antennae are no longer received. When such determination can no longer be made, the computer's lock status is fixed and the computer is thus placed in a state in which the computer may be accessed for illegal purposes despite the source actually being out of communication range.

Accordingly, the critical part of the security system needs to continue to operate even when part of the security system becomes non-functional.

An object of the present invention is to provide a computer lock system that is implemented by a computer body and a wireless receiver connected to the computer body and that can prevent unauthorized use by a third party even when the wireless receiver is detached.

### Means for Solving the Problems

In order to solve the above-described object, the present invention is configured by including the following matters specifying the invention or technical features. Specifically, the invention according to an aspect is a computer lock system comprising a computer body and a wireless receiver connected to the computer body.

The wireless receiver includes: a signal receiving unit that receives a wireless signal that may include noise or be in a no-signal state; and a signal outputting unit that outputs the received wireless signal to the computer body.

The computer body may include: a signal acquisition unit that acquires the signal output from the signal outputting unit; an ID determination unit that determines, in an intermittent manner, whether an unlock ID, which is an ID for enabling usual access to a display interface of the computer body, is contained in the signal acquired (the acquired signal) by the signal acquisition unit; an accessible status information holding unit that holds accessible status information that indicates whether or not the usual access to the display interface of the computer body is enabled, the indication being determined based on the acquired signal; an access-enabling unit that changes, when the ID determination unit determines that a valid unlock ID is contained, the accessible status information held in the accessible status information holding unit to an accessible status for enabling the usual access to the display interface of the computer body; an access-disabling unit that changes, when the ID determination unit determines that a valid unlock ID is not contained, the accessible status information held in the accessible status information holding unit to an inaccessible status for causing the display interface of the computer body to disable the usual access to a display; and a control unit that controls the display interface based on the accessible status information held in the accessible status information holding unit.

In addition, the signal acquisition unit, the ID determination unit, the accessible status information holding unit, the access-enabling unit, the access-disabling unit and the control unit of the computer body may be configured to be operative whenever the computer is in operation.

In addition, the signal receiving unit and the signal outputting unit may be configured to be operative whenever the wireless receiver is connected to the computer body that is in operation.

In addition, the computer body may further include: a screen saver unit that displays and outputs a screen saver screen when no input is made from a user interface for a predetermined period of time; and a conflict coordinating unit that performs coordination such that an operation of the control unit is given priority when the operation of the control unit and an operation of the screen saver unit conflict with each other.

In addition, the computer body may further includes: a password entry accepting unit that accepts an entry of a password, when the ID determination unit determines that the valid unlock ID is not contained and when the display interface of the computer body is in a state in which the usual access to the display is disabled; a password determination unit that determines whether or not the entered password is correct; and an accessible status fixing unit that fixes the accessible status information in the accessible status information holding unit to the accessible status when the password determination unit determines that the password is correct.

In addition, the computer body may further include: an inactivation unit that inactivates, when the accessible status information is fixed to the accessible status by the accessible status fixing unit, functions in order to prevent the display interface of the computer body from disabling the usual access to the display by means of the signal acquisition unit, the determination unit and the access-disabling unit of the computer body.

In addition, the computer body and the wireless receiver may be connected to each other via a USB cable. The signal outputting unit and the signal acquisition unit of the computer body may exchange signals by the USB cable. The wireless receiver may be power-fed through the USB cable.

In addition, the signal receiving unit may be configured to receive a wireless signal from an RFID device.

In addition, in the above-described computer lock system, the computer body may further include: a network signal determination unit that receives, via a network, an acquired signal of a signal acquisition unit of another computer body connected via the network and that determines whether or not the unlock ID is contained in the received acquired signal; and a network interface signal outputting unit that transmits an interface signal that indicates that the interface of the computer body is in the usual accessible state to the another computer body via the network, when the network signal determination unit determines that the unlock ID is contained.

The invention according to another aspect is a method of operating a computer lock system comprising a computer body and a wireless receiver connected to the computer body. The wireless receiver performs: a wireless signal receiving step of receiving a wireless signal that may include noise or be in a no-signal state; and a signal outputting step of outputting the received wireless signal to the computer body. The computer body performs: a signal acquisition step of acquiring the signal output from a signal outputting unit; an ID determination step of determining whether or not an unlock ID, which is an ID for enabling usual access to a display interface of the computer body, is contained in an acquired signal from the signal acquisition step; an accessible status information holding step of holding accessible status information that indicates whether or not the usual access to the display interface of the computer body is enabled, the indication being determined based on the acquired signal; an access-enabling step of changing, when the ID determination step determines that a valid unlock ID is contained, the accessible status information held in an accessible status information holding step to an accessible status for enabling the usual access to the display interface of the computer body; an access-disabling step of changing, when the ID determination step determines that a valid unlock ID is not contained, the accessible status information held in the accessible status information holding step to an inaccessible status for causing the display interface of the computer body to disable the usual access to a display; and a controlling step of controlling the display interface based on the accessible status information held in the accessible status information holding step

The invention according another aspect is a computer program that runs on a computer body. A wireless receiver may be connected to the computer body. The wireless receiver may comprise: a signal receiving unit that receives a wireless signal that may include noise or be in a no-signal state; and a signal outputting unit that outputs the received signal to the computer body.

The computer program is configured to cause the computer body to perform: a signal acquisition step of acquiring the signal output from the signal outputting unit; an ID determination step of determining whether or not an unlock ID, which is an ID for enabling usual access to a display interface of the computer body, is contained in an acquired signal from the signal acquisition step; an accessible status information holding step of holding accessible status information that indicates whether or not the usual access to the display interface of the computer body is enabled, the indication being determined based on the acquired signal; an access-enabling step of changing, when the ID determination step determines that a valid unlock ID is contained, the accessible status information held in the accessible status information holding step to an accessible status for enabling the usual access to the display interface of the computer body; an access-disabling step of changing, when the ID determination step determines that a valid unlock ID is not contained, the accessible status information held in the accessible status information holding step to an inaccessible status for causing the display interface of the computer body to disable the usual access to a display; and a controlling step of controlling the display interface based on the accessible status information held in the accessible status information holding step.

### Effect of the Invention

According to the above-described configurations, a computer lock system is provided which comprises a computer body and a wireless receiver connected to the computer body and which is capable of preventing unauthorized use by a third party even when the wireless receiver is detached.

### BRIEF DESCRIPTION OF THE DRAWINGS

FIG. 1 is a conceptual diagram of a computer lock system according to Embodiment 1.

FIG. 2 is a functional block diagram of the computer lock system according to Embodiment 1.

FIG. 3 is a diagram for explaining an acquired signal in a signal acquisition unit of a computer body according to Embodiment 1.

FIG. 4 is a diagram showing a hardware configuration example of the computer lock system according to Embodiment 1.

FIG. 5 is a processing flowchart of the computer lock system according to Embodiment 1.

FIG. 6 is a diagram for explaining computer lock systems according to Embodiments 2 and 3.

FIG. 7 is a functional block diagram of a computer lock system according to Embodiment 4.

FIG. 8 is a diagram for explaining the interface usage when a control unit and a screen saver unit of the computer lock system according to Embodiment 4 are in a state of conflict.

FIG. 9 is a diagram showing a hardware configuration example of the computer lock system according to Embodiment 4.

FIG. 10 is a processing flowchart of the computer lock system according to Embodiment 4.

FIG. 11 is a functional block diagram of a computer lock system according to Embodiment 5.

FIG. 12 is a diagram showing a hardware configuration example of the computer lock system according to Embodiment 5.

FIG. 13 is a processing flowchart of the computer lock system according to Embodiment 5.

FIG. 14 is a functional block diagram of a computer lock system according to Embodiment 6.

FIG. 15 is a diagram showing a hardware configuration example of the computer lock system according to Embodiment 6.

FIG. 16 is a processing flowchart of the computer lock system according to Embodiment 6.

FIG. 17 is a functional block diagram of computer lock systems according to Embodiments 7 and 8.

FIG. 18 is a conceptual diagram of a network connection-enabled version of a computer lock system according to Embodiment 9.

FIG. 19 is a functional block diagram of the computer lock system according to Embodiment 9.

FIG. 20 is a diagram showing a hardware configuration example of the computer lock system according to Embodiment 9.

FIG. 21 is a processing flowchart of the computer lock system according to Embodiment 9.

### EMBODIMENTS OF THE INVENTION

Embodiments of the present invention will hereinafter be described with drawings. It should be noted that the present invention is not limited to any of these embodiments in any way and it may be implemented in various aspects without departing from the scope of the invention.

The functional blocks of the present system described hereinafter may be implemented as a combination of hardware and software. In particular, the functional blocks may include: hardware configuration components such as a central processing unit (CPU), a main memory, a system bus, a secondary storage (e.g., a hard disk drive, a non-volatile memory, a storage medium such as a CD, a DVD, etc., and a read drive for such media), an input device used for inputting information, a display device, an antenna, other external peripheral devices and the like; an interface for such external peripheral devices; a communications interface; an RFID; a driver program for controlling such hardware; other application programs; a user interface application; and the like. Data and the like held in the memory or the hard disk are processed or accumulated, and instructions for controlling the above-described hardware and software resources are generated through arithmetic processing by the CPU in accordance with the programs deployed in the main memory. Alternatively, the functional blocks of the present system may be configured by dedicated hardware resources. The present system is not limited to being configured by a single hardware or software resource, and it may be configured by a combination of multiple hardware or software resources or it may be configured with an inclusion of a server device via a network.

In addition, the present invention can not only be implemented as a system but also as a method. Moreover, part of the present invention may be configured as software. Furthermore, it should be understood that a program to be used for causing a computer to execute such software and a recording medium having such program stored therein also fall within the technical scope of the present invention.

### Embodiment 1

### <Outline>

As shown in FIG. 1, the present computer lock system comprises a computer body 0100 and a wireless receiver 0101 externally connected to the computer body 0100. The system is configured to: automatically lock a computer interface (e.g. a display interface) (the right figure in FIG. 1) when, for example, a user logged in and working on the computer (the left figure in FIG. 1) leaves his/her seat; and automatically unlock the computer interface upon receiving an unlock ID contained in a wireless signal from the wireless receiver 0101 when the user returns to and approaches his/her seat. FIG. 1 also shows, as other hardware, a display 0102 and a keyboard 0103 which are used by the user while he/she is working. The display screen in the figure on the left-hand side in FIG. 1 shows a screen when the user is working and the display screen in the figure on the right-hand side in FIG. 1 shows a computer lock screen. For the unlock ID, an RFID device without a power supply held by the user may be utilized.

### <Configurations>

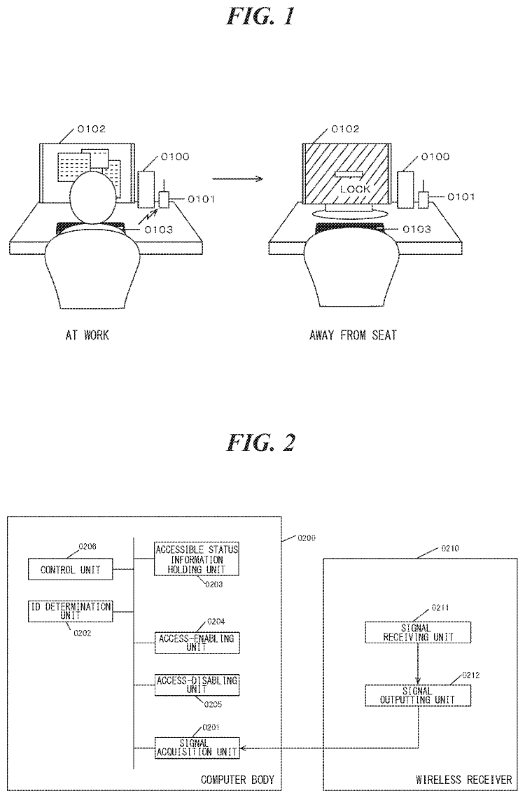

As shown in FIG. 2, the computer lock system according to Embodiment 1 is implemented by, for example, the computer body 0200 and the wireless receiver 0210. The wireless receiver 0210 comprises, for example, a wireless signal receiving unit 0211 and a received signal outputting unit 0212. The computer body 0200 comprises, for example, a received signal acquisition unit 0201, an ID determination unit 0202, an accessible status information holding unit 0203, an access-enabling unit 0204, an access-disabling unit 0205 and a control unit 0206.

### <Wireless Receiver>

The wireless receiver 0210 has an antenna for receiving a wireless signal and is externally connected to the computer body 0200. A user is logged in and working on the computer at his/her desk in his/her office (the left figure in FIG. 1). When the user temporarily leaves his/her desk (the right figure in FIG. 1) partway through working and moves out of the effective communication range of the wireless receiver 0210, the wireless receiver 0210 loses communication with the user who has the unlock ID and thus the computer is automatically locked. Specifically, the computer lock screen such as that shown in the figure on the right-hand side in FIG. 1 is displayed when the user is away from his/her desk. When the user then approaches or returns to his/her seat, i.e. when the user enters the effective communication range of the wireless receiver 0210, the wireless receiver 0210 receives a wireless signal containing the unlock ID (e.g. stored in a card or an RFID tag possessed by the user) possessed by the user, and the wireless receiver 0210 then passes on the unlock ID from the received wireless signal to the computer body 0200 to unlock the locked computer and release the computer from the inaccessible state. An ID that allows the wireless receiver 0210 to be recognized may be output from the received signal outputting unit 0212 with respect to the computer body 0200.

### <Wireless Signal Receiving Unit>

The signal receiving unit 0211 receives a wireless signal that may contain noise or be in a no-signal state. The wireless signal may be sent from an RFID without a power supply, near-field communication and the like. The received wireless signal (antenna signal) may contain noise or be in a no-signal state, and the above-described unlock ID and the like are also contained therein.

### <Received Signal Outputting Unit>

The received signal outputting unit 0212 outputs the received wireless signal to the computer body 0200. The output of the received signal outputting unit 0212 is input to the received signal acquisition unit 0201 of the computer body 0200. The antenna signal may or may not contain the unlock ID. The received signal outputting unit 0212 may output an ID for causing the computer body 0200 to which the wireless receiver is connected to recognize the wireless receiver.

### <Computer Body>

The computer body 0200 corresponds to a computer, a notebook PC, a tablet PC and the like. The display may be separate from or integrated with the computer body 0200, and as described below, the display interface is locked or unlocked. Use of the computer lock system of the present disclosure is assumed to be made in environments, such as offices, city halls, public institutions and the like, where multiple users work on a computer, thereby the computer body 0200 is locked, without a user performing any operation, even when the user leaves his/her desk partway through working. The system is capable of unlocking the computer body 0200 when the user returns to his/her seat and if the unlock ID is contained in the wireless signal received via the wireless receiver 0210 externally connected to the computer body 0200. The effective transmission range (effective communication range) between the wireless receiver 0210 externally connected to the computer body 0200 and the user in possession of the unlock ID is set in the range of one to two meters. It should be noted that the wireless receiver 0210 is configured to be able to change the effective transmission range (effective communication range) through control by the computer body 0200 to which the wireless receiver 0210 is connected. The transmission intensity on the transmission side and the receiving sensitivity on the receiving side may be adjusted through operations of the user interface. For example, when the installation interval of the computer is as small as less than one meter, the effective transmission range (effective communication range) may be set to less than one meter.

### <Received Signal Acquisition Unit>

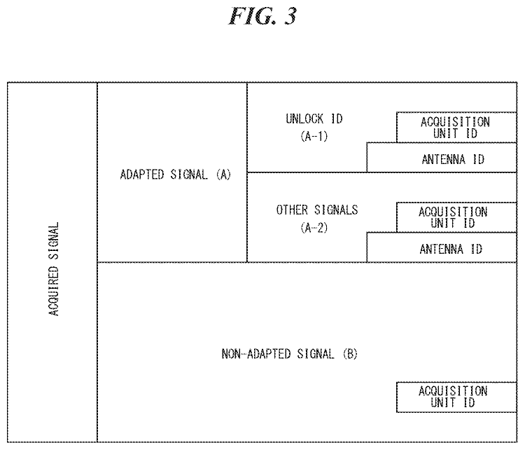

The received signal acquisition unit 0201 acquires the signal output from the received signal outputting unit 0212. The received signal acquisition unit 0201 may acquire an adapted signal and/or a non-adapted signal, such as those shown in FIG. 3 described below.

### <ID Determination Unit>

The ID determination unit 0202 determines, in an intermittent manner, whether the unlock ID, which is an ID for enabling the usual access to the display interface of the computer body 0200, is contained in the signal acquired by the received signal acquisition unit 0201.

As shown in FIG. 3, the above-described acquired signal comprises the adapted wireless signal (adapted signal) and/or the wireless signal that is not adapted (non-adapted signal). As to the forms of the acquired signal, the acquired signal may contain the adapted signal (A) or the non-adapted signal (B). In a case of the adapted signal (A), the acquired signal may further contain only an unlock ID (A-1), or the unlock ID (A-1) and other signals (A-2). When both the adapted signal (A) and the non-adapted signal (B) are contained, the acquired signal may further contain only the unlock ID (A-1), or the unlock ID (A-1) and other signals (A-2).

The unlock ID and the other signals of the adapted signal (A) contain acquisition unit IDs associated with antennae IDs. The non-adapted signal contains an acquisition unit ID without an antenna ID. Here, the non-adapted signal may also contain a noise current that occurs at an outlet for the receiver of the computer body 0200 when, for example, the wireless receiver 0210 is not connected. Accordingly, even when the acquired signal does not contain the antenna ID and a determination is made that part of the computer lock system is non-functional, the ID determination unit 0202 or the respective units that use the determination result from the ID determination unit 0202 are configured to continue functioning. The other signals in the wireless signal may contain a parameter modifying key for modifying parameters, etc. of the respective units including the ID determination unit 0202, the accessible status information holding unit 0203, the access-enabling unit 0204, the access-disabling unit 0205, the control unit 0206 and the like. It is also possible that the ID determination unit 0202 may be configured to determine whether the parameter modifying key is included, and according to the determination made, the parameters of the respective units may be modified through the interfaces of the computer body 0200. An example of the parameter of the ID determination unit 0202 may include the unlock ID. Examples of the parameters of the accessible status information holding unit 0203 may include the accessible status itself, the effective period of the accessible status, the history accumulation period of the accessible status or the like. An example of the parameters of the access-enabling unit 0204 and the access-disabling unit 0205 may include, if there are a plurality of accessible status information holding units 0203, deciding which one of the accessible status information holding units 0203 is to be set in (updated to) an accessible status or an inaccessible status.

The case where there is a plurality of accessible status information holding units 0203 refers to the case where there is a plurality of login users registered with the OS (the accessible files, the accessible databases, the accessible external connected devices, the accessible networks and the accessible applications may vary depending on the login users). Under this situation, when the computer body 0200 acquires the unlock ID for user A and the lock is released, user A can login and use the computer body 0200 in a usual manner; however, other users including user B cannot login during this time.

An example of the parameter of the control unit 0206 may include a parameter that selects the type of display interface to be controlled. For example, if a plurality of displays is connected to a single computer, the parameter enables the selection between the configuration in which all of the displays being enabled for the usual manipulation or the configuration in which only some of the displays being enabled for the usual manipulation. The control unit 0206 may also be configured such that it operates in accordance with a parameter that enables to change the control of the display interface depending on the period of time or the time of day.

The ID determination unit 0202 determines, in an intermittent manner, whether the adapted signal and/or the non-adapted signal are/is contained based on such acquired signal, and thus, even when the wireless receiver externally connected to the computer body is detached, the locking and unlocking of the computer can be performed based on the acquired signals without being affected by the detachment.

For example, if the computer has been locked and the display interface has been rendered inaccessible, when the ID determination unit 0202 determines that the unlock ID is contained, the access-enabling unit 0204 changes the accessible status information in the accessible status information holding unit 0203 to the accessible status and the control unit 0206 unlocks the computer. When the unlock ID is not contained, the computer continues to be locked. This operation of the ID determination unit may preferably be performed in an intermittent manner. The intermittent time interval is selected depending on the work content; however, it may be set to any time between a few seconds and a few dozen seconds for usual work. The computer body may be provided with a time interval adjusting unit for adjusting the intermittent time interval.

### <Accessible Status Information Holding Unit>

The accessible status information holding unit 0203 holds accessible status information that indicates whether or not the usual access to the display interface of the computer body 0200 is enabled, wherein such indication is determined based on the acquired signal. The state in which the usual access to the display interface is enabled refers to the state in which data input from the keyboard or the mouse connected to the computer body or working instructions by means of a mouse cursor is enabled. In this regard, the cursor movement and key operation for entering a password in the computer lock screen are designed to be enabled even when the computer is locked; however, this state in which the above is enabled is not referred to as the state in which the usual access is enabled.

### <Access-Enabling Unit>

When the ID determination unit 0202 determines that a valid unlock ID is contained, the access-enabling unit 0204 sets the accessible status information in the accessible status information holding unit 0203 to the accessible status for enabling the usual access to the display interface of the computer body 0200.

### <Access-Disabling Unit>

When the ID determination unit 0202 determines that a valid unlock ID is not contained, the access-disabling unit 0205 sets the accessible status information in the accessible status information holding unit 0203 to the inaccessible status for causing the display interface of the computer body 0200 to disable the usual access to the display.

### <Control Unit>

The control unit 0206 controls the display interface based on the accessible status information held in the accessible status information holding unit 0203. If the accessible status information indicates the accessible status, the control unit 0206 performs control such that the usual access to the display interface is enabled. If the accessible status information indicates the inaccessible status, the control unit 0206 performs control such that the usual access to the display interface is disabled. The state in which the lock screen configured to accept the entry of a password for unlocking is displayed corresponds to the state in which the usual access to the display interface is disabled, as the display interface only has a password accepting function and the usual work therefore cannot be started immediately. However, the computer lock screen is not limited to the above-described screen, and the screen may be configured so as not to accept any entry of a password. In such case, input from input devices, such as the mouse, the keyboard or the like, may also be rejected.

In the above-described computer lock system, the wireless receiver 0210 may be connected to the computer body 0200 in a detachable manner. Even when the wireless receiver 0210 is detached from the computer body 0200 when the computer body 0200 is locked, since the computer body 0200 determines whether the adapted signal and/or the non-adapted signal are/is contained based on the above-described acquired signal, the security can be maintained. In other words, the computer body 0200 can be placed in a secure condition regardless of whether the wireless receiver 0210 is detached or not detached from the computer body 0200.

In addition, use by a third party is also disabled even when the wireless receiver 0210 is replaced with another wireless receiver.

### <Computer Body>

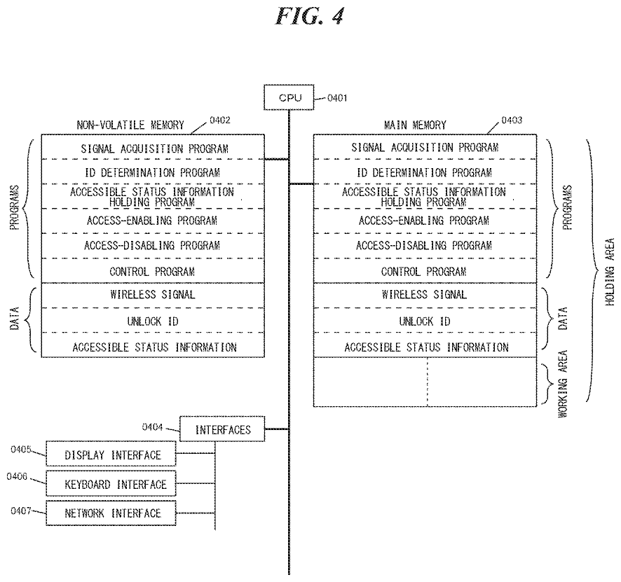

As shown in FIG. 4, the computer body 0200 is configured to include: a CPU 401; a non-volatile memory 0402, such as an HDD, ROM, etc.; a main memory 0403, such as D-RAM, etc.; and an interface 0404. The non-volatile memory 0402 stores therein various programs such as an antenna signal acquisition program, an ID determination program, an accessible status information holding program, an access-enabling program, an access-disabling program, a control program, etc. Data includes the received wireless signal, the unlock ID, data based on the accessible status information, etc. Under control of the CPU 401, these programs are deployed in a predetermined area in the main memory 0403 and executed based on various kinds of data. The interface 0404 includes a display interface 0405, a keyboard interface 0406, a network interface 0407, etc.

### <Processing Flow>

As shown in FIG. 5, the wireless receiver 0210 performs, in accordance with a wireless signal receiving program, a signal receiving step (step 0501) of receiving the wireless signal that may contain noise or be in a no-signal state. This wireless signal is sent from, for example, an RFID device without a power supply, etc. A determination is made on the computer body 0200 side as to whether the unlock ID is contained in the wireless signal.

Next, the wireless receiver 0210 performs, in accordance with the execution of a signal output program, a signal outputting step (step 0502) of outputting the received wireless signal to the computer body 0200. By this processing, the received wireless signal is input to the computer body 0200 to which the wireless receiver is externally connected.

Then, the above-described computer body 0200 performs, in accordance with the signal acquisition program, an antenna signal acquisition step (step 0503) of acquiring the antenna signal output from the received signal outputting unit 0212 of the wireless receiver.

Next, the computer body 0200 performs, in accordance with the ID determination program, a determination step (step 0504) of determining, in an intermittent manner, whether the unlock ID, which is an ID for enabling the usual access to the display interface of the computer body 0200, is contained in an acquired signal from the antenna signal acquisition step 0503. Here, the intermittent determination operation is usually performed at an interval set to any time between a few seconds and a few dozen seconds.

Next, if the determination step 0504 determines that a valid unlock ID is contained, the computer body 0200 performs, in accordance with the access-enabling program, an access-enabling step (step 0505) of setting the accessible status information in the accessible status information holding unit 0203 to the accessible status for enabling the usual access to the display interface of the computer body 0200.

In this case, in accordance with the accessible status information holding program, the accessible status information that is determined and set based on the acquired signal is held in the accessible status information holding unit 0203 at all times. The accessible status information is therefore changed to the accessible status through the access-enabling step and held in the accessible status information holding unit. Moreover, the unlock ID and the login user information of the corresponding computer body 0200 are associated with each other and held in the accessible status information holding unit. If there is a plurality of computer bodies 0200, the unlock IDs may be set individually; however, in an environment where a computer body 0200 is shared, a single unlock ID may be shared by users or a plurality of corresponding unlock IDs may be set. Moreover, in offices or public institutions, the system may be set such that a separate unlock ID is preferably set in order to render the computer body 0200 accessible even when the user in charge of such computer body 0200 takes a leave of absence.

On the other hand, if the determination step 0504 determines that a valid unlock ID is not contained, the computer body 0200 performs an access-disabling step (step 0506) so as to set the accessible status information from the accessible status information holding step to the inaccessible status for causing the display interface of the computer body 0200 to disable the usual access to the display.

Here, if the authentic unlock ID is not contained, when the computer body 0200 has been locked, then the computer body 0200 continues to be locked. In addition, even when a tag, etc. having the unlock ID associated with the computer body 0200 is brought close to another computer body, the locked status is not released. Accordingly, the display interface of the another computer body is still in the inaccessible state. The information on the inaccessible state is held in the accessible status information holding unit 0203.

Next, the computer body 0200 performs, in accordance with the control program, a controlling step (step 0507) of controlling the display interface based on the accessible status information held in the accessible status information holding unit 0203.

If the use of the computer by the user is not terminated (step 0508), the computer body 0200 returns to the above-described signal acquisition step and the above-described steps are repeated. If the use of the computer is terminated (step 0508), for example, when the computer is turned off, the computer body 0200 terminates the processing.

When the computer is turned on again, the computer body 0200 activates the computer lock system and automatically controls the lock state and the unlock state based on the unlock ID assigned to the computer body 0200 and the user status information without requiring any user operations.

As described above, according to Embodiment 1, in a computer lock system implemented by a computer body 0200 and a wireless receiver 0210 externally connected to the computer body 0200, security can be maintained security even when the wireless receiver 0210 is detached.

### Embodiment 2

### <Outline>

Embodiment 2 is a modification of Embodiment 1 and has a feature in the point that the received signal acquisition unit 0201, the ID determination unit 0202, the accessible status information holding unit 0203, the access-enabling unit 0204, the access-disabling unit 0205 and the control unit 0206 of the computer body 0200 are configured to be in the operational status whenever the computer body 0200 is in operation.

### <Configurations>

As shown in FIG. 2, the computer lock system according to Embodiment 2 comprises the computer body 0200 and the wireless receiver 0210. The wireless receiver 0210 comprises the wireless signal receiving unit 0211 and the received signal outputting unit 0212. The computer body 0200 comprises the received signal acquisition unit 0201, the ID determination unit 0202, the accessible status information holding unit 0203, the access-enabling unit 0204, the access-disabling unit 0205 and the control unit 0206. The received signal acquisition unit 0201, the ID determination unit 0202, the accessible status information holding unit 0203, the access-enabling unit 0204, the access-disabling unit 0205 and the control unit 0206 of the computer body 0200 are configured to be in the operational status whenever the computer is in operation.

### <Description of Configurations and Functions>

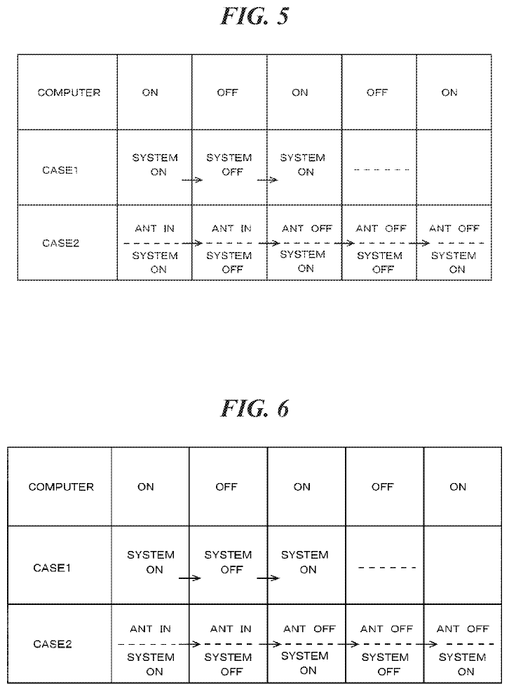

As shown in FIG. 6, in the example of CASE 1, whenever the computer body 0200 is turned on (i.e. the computer body is in operation), the present computer lock system is also turned on, and the received signal acquisition unit 0201, the ID determination unit 0202, the accessible status information holding unit 0203, the access-enabling unit 0204, the access-disabling unit 0205 and the control unit 0206 become operative. For example, when the functions of the present computer lock system are implemented by software, the software for the computer lock system is installed as an application and resides on the OS of the computer body 0200. If the computer body 0200 is then turned on, the ID determination unit 0202 makes the determination regarding the acquired signal from the received signal acquisition unit 0201 of the computer body 0200 and thus the computer lock system operates normally. If the computer body 0200 is turned off, the present computer lock system is also turned off. Namely, the received signal acquisition unit 0201, the ID determination unit 0202, the accessible status information holding unit 0203, the access-enabling unit 0204, the access-disabling unit 0205 and the control unit 0206 of the computer body 0200 become inoperative. The computer lock system is thus turned on or off in tandem with the computer body being turned on or off.

As shown in FIG. 6, the example of CASE 2 shows the case when the wireless receiver 0210 is connected or not connected to the computer body 0200. Whenever the computer body 0200 is turned on while the wireless receiver 0210 is externally connected to the computer body 0200, the present computer lock system is also turned on. Namely, the received signal acquisition unit 0201, the ID determination unit 0202, the accessible status information holding unit 0203, the access-enabling unit 0204, the access-disabling unit 0205 and the control unit 0206 of the computer body 0200 become operative. If the computer body 0200 is turned off, the present computer lock system is also turned off even when the wireless receiver 0210 is externally connected. Namely, the received signal acquisition unit 0201, the ID determination unit 0202, the accessible status information holding unit 0203, the access-enabling unit 0204, the access-disabling unit 0205 and the control unit 0206 of the computer body 0200 become inoperative.

Even when the wireless function is turned off (i.e. the wireless receiver is detached), when the computer body 0200 is turned on, the present computer lock system is also turned on and becomes operative. Namely, the present computer lock system operates without a booting instruction from the application. When the computer body 0200 is turned off while the wireless function is turned off, the present computer lock system is also turned off and the lock control operation is terminated. The present computer lock system continues to operate even when the wireless receiver 0210 is removed while the computer body 0200 is turned on.

As described above, according to Embodiment 2, in addition to the advantage of Embodiment 1, since the computer lock system is operative whenever the computer is in operation with or without the wireless receiver being externally connected thereto, security can be continuously maintained while the computer is in operation.

### Embodiment 3

### <Outline>

Embodiment 3 is a modification of either Embodiment 1 or 2 and has a feature in the point that the wireless receiver 0210 is configured to be operative whenever the wireless receiver 0210 is externally connected to the computer body that is in operation.

### <Configurations>

As shown in FIG. 2, the computer lock system according to Embodiment 3 is implemented by the computer body 0200 and the wireless receiver 0210. The wireless receiver 0210 comprises the wireless signal receiving unit 0211 and the received signal outputting unit 0212. The computer body 0200 comprises the received signal acquisition unit 0201, the ID determination unit 0202, the accessible status information holding unit 0203, the access-enabling unit 0204, the access-disabling unit 0205 and the control unit 0206. The wireless signal receiving unit 0211 and the received signal outputting unit 0212 of the wireless receiver 0210 are configured to be operative whenever the wireless receiver 0210 is externally connected to the computer body 0200 that is in operation.

### <Description of Configurations and Functions>

The configurations and functions of Embodiment 3 are similar to those of CASE 2 of Embodiment 2 in FIG. 6 and the description thereof will therefore be omitted.

In Embodiment 3, the wireless receiver 0210 externally connected to the computer body 0200 is powered from the antenna signal acquisition unit 0201 of the computer body 0200, and thus the wireless receiver has no switch for turning the wireless receiver off. Namely, the wireless receiver 0210 does not have a function of turning off by itself.

In the above-described example of Embodiment 3, the wireless receiver 0210 is configured such that it does not have a power supply. If the computer body 0200 is a battery-driven notebook computer, a compact tablet computer, etc., it may be considered that the power capacity is insufficient. Accordingly, in such case, the wireless receiver 0210 may be configured to be supplied from an external power supply or it may be configured to be provided inside thereof with a battery, a rechargeable secondary battery, such as a lithium-ion battery, a nickel-hydrogen battery, etc.

As described above, according to Embodiment 3, in addition to the advantage of Embodiment 1 or 2, since the power is supplied whenever the wireless receiver 0210 is connected to the computer body, the wireless signal receiving unit 0211 and the received signal outputting unit 0212 of the wireless receiver 0210 are operative, the locking and unlocking of the computer are performed on a continuous basis.

### Embodiment 4

### <Outline>

Embodiment 4 is a modification of Embodiments 1 to 3 and has a feature in the point that a function is provided for coordinating conflicts between a screen saver and the computer lock system.

### <Configurations>

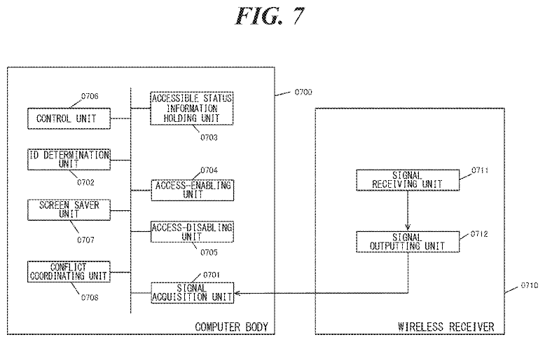

As shown in FIG. 7, the computer lock system according to Embodiment 4 is implemented by the computer body 0700 and the wireless receiver 0710. The wireless receiver 0710 comprises the wireless signal receiving unit 0711 and the received signal outputting unit 0712. The computer body 0700 comprises the received signal acquisition unit 0701, the ID determination unit 0702, the accessible status information holding unit 0703, the access-enabling unit 0704, the access-disabling unit 0705 and the control unit 0706, and further comprises a screen saver unit 0707 and a conflict coordinating unit 0708.

### <Description of Configurations>

### <Screen Saver Unit>

The screen saver unit 0707 displays a screen saver screen when no input is made from the interface(s) for a predetermined time period. The input from the interface(s) includes an input from an input device, such as a keyboard, a mouse and the like. When there is no such input for a predetermined time period, the screen saver unit 0707 performs control such that the screen saver screen is displayed. Typically, the predetermined time period can be set by a user to be any time between a few minutes and a few dozen minutes. It is considered that the user often sets the predetermined time period to a few minutes or so when such screen saver function is used for the locking purpose such that the computer body 0700 cannot be accessed by another person without permission when, for example, the user is away from his/her desk. For example, if the computer body is installed with a Windows (registered trademark) operating system (OS) (e.g. Windows 10, Windows 8.1, Windows 7, etc.), the user may set the screen saver by causing the control panel screen to be displayed and selecting “Personalize” through the desktop customization. If the “On resume, display logon screen” check box is checked on the screen saver screen, the logon screen is displayed and entry of a password is requested when the user interrupts the screen saver for performing input operations, etc. (for example, the interruption is triggered by interface input such as moving the mouse or performing key input from the keyboard). If a no-screen-saver setting is made, no problems occur in the present computer lock system since the screen saver screen will not be displayed. If the above-described “On resume, display logon screen” check box is checked, the conflict between the operation of the control unit 0706 and the operation of the screen saver unit 0707 needs to be taken into consideration since there is a risk of conflict with the present computer lock system.

### <Conflict Coordinating Unit>

The conflict coordinating unit 0708 performs control such that it gives priority to the operation of the control unit 0706 when the operation of the control unit 0706 and the operation of the screen saver unit 0707 conflict with each other. It should be noted that the operation of the screen saver unit may include both the displaying of the screen saver screen and the displaying of the logon screen at the time of resuming work.

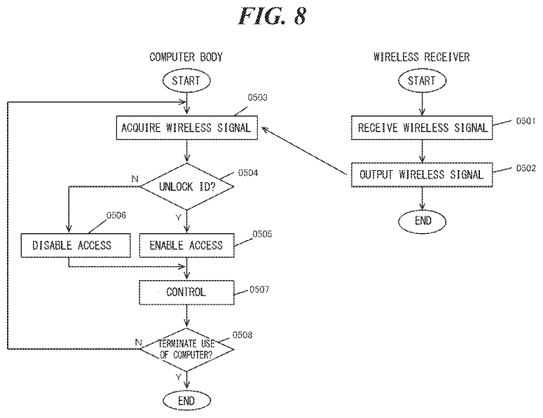

FIG. 8 describes the use of the interface when the operation of the control unit 0706 and the operation of the screen saver unit 0707 conflict with each other as described above. The “OK” in the “use of interface” column in FIG. 8 refers to case (1) where a screen saver is not activated and case (2) where a screen saver is activated but entry of a password is not required.

As shown in FIG. 8, when the operation of the screen saver unit 0707 is “OK” and the operation of the control unit 0706 is “OK,” then the “use of interface” is also “OK.” Even when the operation of the screen saver unit 0707 is “NG” (i.e., the screen saver unit 0707 determines that the displaying of the screen saver screen or the displaying of the logon screen should be performed), if the operation of the control unit 0706 is “OK,” the “use of interface” is then also “OK” and the operation of the control unit 0706 is given priority. Moreover, even when the operation of the screen saver unit 0707 is “OK” (i.e., the screen saver unit 0707 determines that the displaying of the screen saver screen or the displaying of the logon screen should not be performed), if the operation of the control unit 0706 is “NG,” the operation of the control unit 0706 is then given priority and the “use of interface” becomes “NG.” If both the operation of the screen saver unit 0707 and the operation of the control unit 0706 are “NG,” then the “use of interface” is also “NG.”

The other configurations are similar to those of Embodiment 1 in FIG. 2 and the description thereof will therefore be omitted.

### <Computer Body>

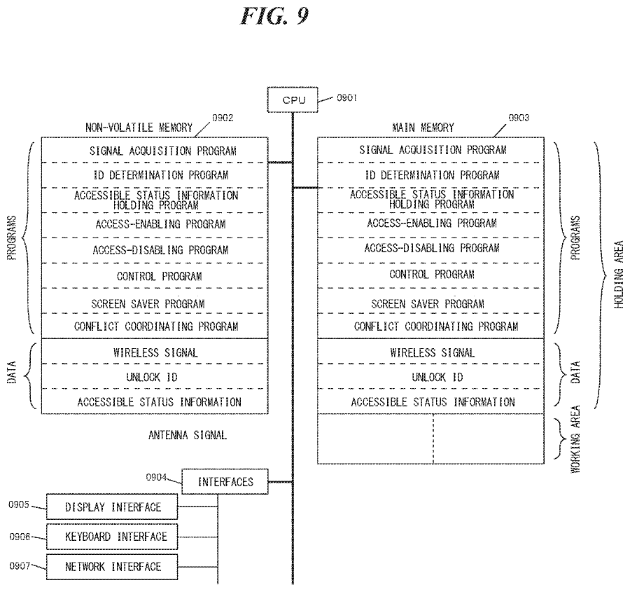

As shown in FIG. 9, the computer body 0700 may be configured by: the CPU 0901; the non-volatile memory 0902, such as an HDD, ROM, etc.; the main memory 0903, such as D-RAM, etc.; the interface 0904; the display interface 0905; the keyboard interface 0906 and the network interface 0907. The non-volatile memory 0902 stores therein programs such as a screen saver program, a conflict coordinating program, etc. Data includes the received wireless signal, the unlock ID, data based on the accessible status information, etc. Under control of the CPU 0901, these programs are deployed in a predetermined area in the main memory 0903 and executed based on various kinds of data. The other programs are similarly configured to those of Embodiment 1 in FIG. 4 and the description thereof will therefore be omitted.

### <Processing Flow>

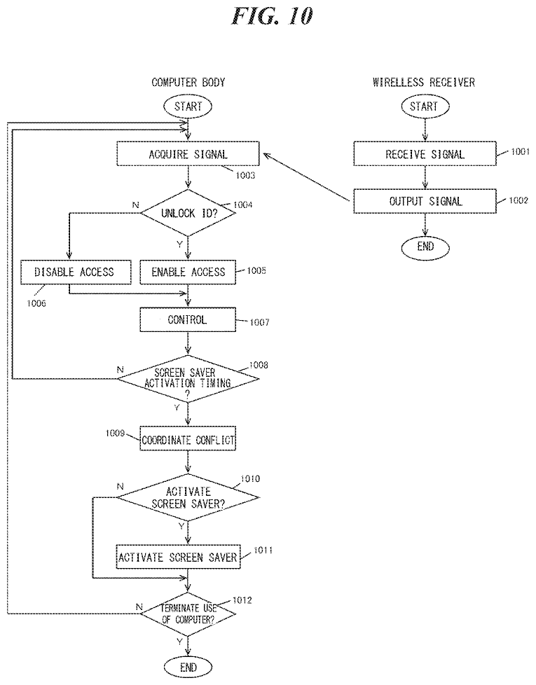

As shown in FIG. 10, in accordance with the performance of the signal receiving step 1001 and the signal outputting step 1002, the signal received by the wireless receiver 0710 is input into the computer body 0700 to which the wireless receiver is externally connected. The processing in the signal receiving step 1001 and the signal outputting step 1003 is similar to that in the wireless signal receiving step 0501 and the received signal outputting step 0502 of Embodiment 1 in FIG. 5 and the description thereof will therefore be omitted.

By performing the signal acquiring step 1003, the ID determining step 1004, the access-enabling step 1005, the access-disabling step 1006 and the controlling step 1007, the computer body 0700 determines whether or not the unlock ID is contained in the acquired signal (see FIG. 3) from the received signal acquisition unit 0701 (step 1004), and by performing the access-enabling step 1005 or the access-disabling step 1006, either the accessible status or the inaccessible status is held in the accessible status information holding unit 0703 as the accessible status information. The processing in the processing steps 1003 to 1007 is similar to that in the processing steps 0503 to 0507 of Embodiment 1 in FIG. 5 and the description thereof will therefore be omitted.

Under the above-described conditions, the computer body 0700 performs a screen saver activation timing determining step (step 1008) of determining whether it is the timing for activating the screen saver. If it is determined, based on the determination from the screen saver activation timing determining step 1008, that it is the timing for activating the screen saver, since the control program operation and the screen saver program operation conflict with each other, the computer body 0700 performs a conflict coordinating step (step 1009) that gives priority to the operation of the control unit 0706. Here, in addition to the timing determined by the screen saver unit 0707 that the screen saver should be activated from the state in which the screen saver is not activated, the screen saver activation timing also includes the timing for determining whether the screen saver operation should be continued when such screen saver is already activated. In addition, the activation of the screen saver may also include the displaying of the logon screen, in addition to the displaying of the screen saver.

In response to the coordination result from the conflict coordinating step, the computer body 0700 performs a screen saver activation determining step (step 1010) of determining whether or not the screen saver should be activated. If the activation of the screen saver is permitted in the conflict coordinating step, the computer body 0700 performs a screen saver step (step 1011). In the screen saver step, either the screen saver or the logon screen is displayed on a display. If the screen saver is not to be activated, the control unit 0706 takes over the control. After the screen saver is activated or the control unit 0706 takes over the control, the computer body 0700 performs the use termination determining step (step 1012).

If it is determined, in the use termination determining step, that the use is not terminated, the computer body 0700 returns to the signal acquisition step again. There are two ways of returning: returning to the signal acquisition step with the screen saver being activated; or returning to the signal acquisition step without the screen saver being activated. When the screen saver is activated, this means that the control unit 0706 is disabling the usual access to the display interface in accordance with the inaccessible status, and the conflict coordinating step is then repeated, as long as the above-described control state continues, either for keeping the screen saver activated or for changing the control state to the state in which the usual access to the display interface is enabled. When the ID determination unit 0702 determines that the unlock ID is contained in the acquired signal while the screen saver is still activated, the access-enabling unit 0704 changes the accessible status information to the accessible status, and accordingly, the conflict coordinating unit 0708 performs the conflict coordination in which the control by the control unit 0706 is given priority and the usual access to the display interface is enabled even when the screen saver unlock determination is not made at the screen saver unit 0707. As a consequence, the screen saver unit 0707 makes a determination of no screen saver activation, i.e., it terminates the screen saver and the usual access to the display is enabled.

The computer body 0700 repeats the above-described processing until the user terminates the use of the computer (step 1012).

As described above, according to the present Embodiment 4, in addition to the advantages of Embodiments 1 to 3, since the control by the computer lock system is given priority when, for example, the screen saver of a Windows (registered trademark) computer and the computer lock system conflict with each other, user-friendly security can be implemented.

### Embodiment 5

### <Outline>

Embodiment 5 is a computer lock system that is based on any of Embodiments 1 to 4 and that has a feature in part thereof. The feature of Embodiment 5 lies in the point that, while the usual access to the display interface is disabled (i.e. when the computer is locked), the accessible status information is fixed to the accessible status if the correct password is accepted even when the unlock ID is not contained in the acquired signal.

### <Configurations>

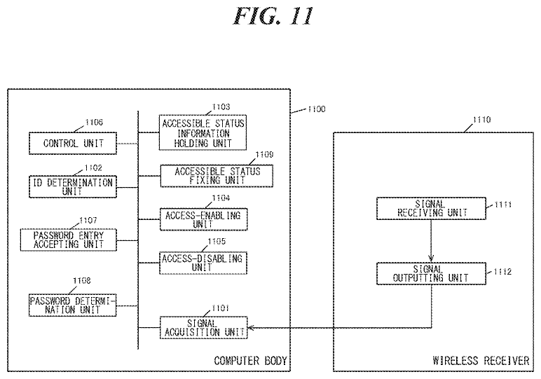

As shown in FIG. 11, the computer lock system according to Embodiment 5 is implemented by the computer body 1100 and the wireless receiver 1110. The wireless receiver 1110 comprises the wireless signal receiving unit 1111 and the received signal outputting unit 1112. The computer body 1100 comprises the received signal acquisition unit 1101, the ID determination unit 1102, the accessible status information holding unit 1103, the access-enabling unit 1104, the access-disabling unit 1105 and the control unit 1106, and further comprises a password entry accepting unit 1107, a password determination unit 1108 and an accessible status fixing unit 1109.

### <Password Entry Accepting Unit>

The password entry accepting unit 1107 determines whether or not a password entry is accepted when the ID determination unit 1102 determines that a valid unlock ID is not contained and when the display interface of the computer body 1100 disables the usual access to the display. For example, when a password is entered from the keyboard connected to the computer body 1101 or the software keyboard displayed on the touch-sensitive screen of a tablet PC, etc., the processing of the password determination unit 1108 is subsequently performed.

### <Password Determination Unit>

The password determination unit 1108 determines whether or not the entered password is correct. For the computer body 1100 implemented by, for example, a Windows (registered trademark) computer, if the entered password is the same as the password set as the login password for such computer body 1100, then it is determined that the entered password is correct.

### <Accessible Status Fixing Unit>

The accessible status fixing unit 1108 forcibly fixes the accessible status information in the accessible status information holding unit 1103 to the accessible status if the password determination unit 1108 determines that the entered password is correct. Namely, the present computer lock system changes and fixes the accessible status information in the accessible status information holding unit 1103 to the accessible status from the inaccessible status if the entered password is correct. Thereby, the usual access to the display interface of the computer body 1100 is enabled. More specifically, the reason for such configuration is because of the need for emergency measures in the event of failure of the unlock ID source or loss of the unlock ID source by the user. Accordingly, the password is preferably held in confidence by a person with higher authority, such as a system administrator in the office. Then, if the ID determination unit 1102 determines, in an intermittent manner, as to whether the unlock ID is contained after the computer is unlocked using such password, a problem occurs to the effect that the unlock state can only be maintained for a few seconds and thus the unlocking and working on the computer body 1101 by the administrator, etc. are rendered substantially unavailable. Accordingly, when the computer is unlocked using a password, the computer body 1100 fixes the accessible status information to the accessible status at all times, instead of performing processing such as determining whether or not the unlock ID is contained. The other configurations are similar to those of Embodiment 1 in FIG. 2 and the description thereof will therefore be omitted.

### <Computer Body>

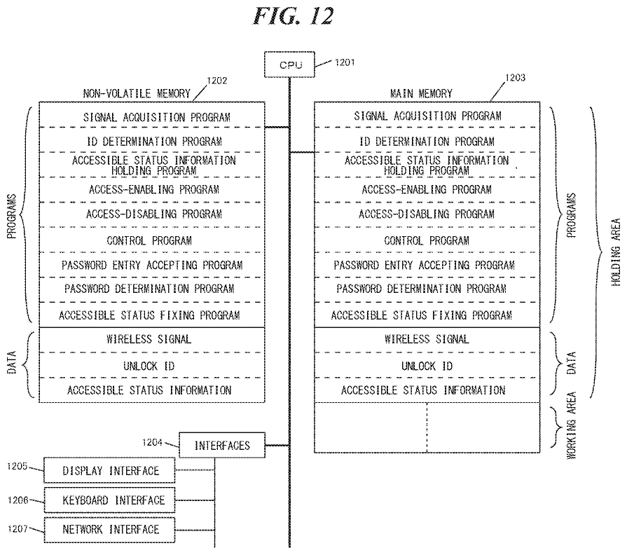

As shown in FIG. 12, the computer body 1100 may be configured by: the CPU 1201; the non-volatile memory 1202, such as an HDD, ROM, etc.; the main memory 1203, such as D-RAM, etc.; the interface 1204; the display interface 1205; the keyboard interface 1206 and the network interface 1207. The non-volatile memory 1202 stores therein programs such as a password entry accepting program, a password determining program, an accessible status fixing program, etc. Data includes the received wireless signal, the unlock ID, data based on the accessible status information, etc. Under control of the CPU 1201, these programs are deployed in a predetermined area in the main memory 1203 and executed based on various kinds of data. The other programs are similar to those of Embodiment 1 shown in FIG. 4 and the description thereof will therefore be omitted.

### <Processing Flow>

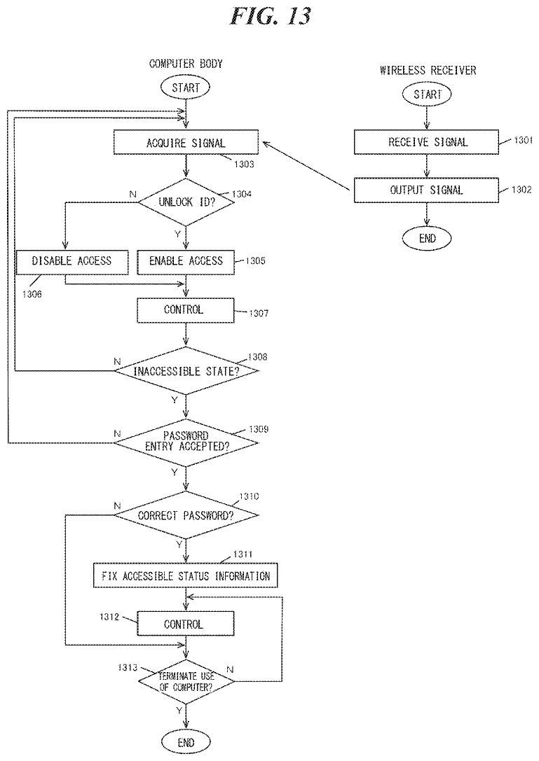

As shown in FIG. 13, in accordance with the performance of the signal receiving step 1301 and the signal outputting step 1302, the wireless receiver 1110 inputs the signal received by the wireless receiver 1110 to the computer body 1100 to which the wireless receiver is externally connected. The processing in the signal receiving step 1301 and the signal outputting step 1302 is similar to that in the signal receiving step 0501 and the signal outputting step 0502 of Embodiment 1 in FIG. 5 and the description thereof will therefore be omitted.

By performing the signal acquiring step 1303, the ID determining step 1304, the access-enabling step 1305, the access-disabling step 1306 and the controlling step 1307, the computer body 1100 determines whether or not the acquired signal (see FIG. 3) from the received signal acquisition unit 1101 contains the unlock ID (step 1304), and by performing the access-enabling step 1305 or the access-disabling step 1306, either the accessible status or the inaccessible status is held in the accessible status information holding unit 1103 as the accessible status information. The processing in the processing steps 1303 to 1307 is similar to that in the processing steps 0503 to 0507 of Embodiment 1 in FIG. 5 and the description thereof will therefore be omitted.

Under the above-described conditions, the computer body 1100 performs a determining step (step 1308) of determining whether or not the display interface of the computer body 1100 is in the inaccessible state in which the usual access to the display is disabled under the lock control by the controlling step 1307. If the display interface is not in the inaccessible state (step 1308), the computer body 1100 returns to the processing in the signal acquiring step 1303.

On the other hand, if it is determined that the display interface is in the state in which the usual access to the display is disabled (i.e. the inaccessible state) (step 1308), the computer body 1100 performs, in accordance with the password entry accepting program, a password entry accepting step (step 1309) of determining whether or not a password entry is accepted. Next, in accordance with the execution of the password determining program, the computer body 1100 performs a password determining step (step 1310) of determining whether or not the entered password is correct. After that, if the password determining step 1310 determines that the entered password is correct, the computer body 1100 performs, in accordance with the accessible status information fixing program, an accessible status fixing step (step 1311) of forcibly fixing the accessible status information in the accessible status information holding unit 1103 to the accessible status.

Following this, the computer body 1100 hands over the control to the lock control processing by the control program (step 1312). While the control unit 1106 performs processing based on the accessible status, the accessible status information is fixed to the accessible status and the control unit 1106 thus performs control such that the computer is in the accessible state in which the usual access to the display is enabled until the use of the computer body 1100 is terminated. Further, the accessible status fixing unit 1108 is preferably configured such that the accessible status information is fixed to the accessible status even when the computer is rebooted after it has been turned off.

Next, the computer body 1100 determines as to whether or not the use of the computer body 1100 by the user is terminated (step 1313). If it is determined that the use is not terminated, the computer body 1100 returns to the controlling step 1312 and the above-described processing is repeated. On the other hand, if the use of the computer body 1100 by the user is terminated (step 1313), for example, when the computer body 1100 is turned off, the computer body 1100 terminates the processing of the computer lock system.

As described above, according to Embodiment 5, in addition to the advantages of Embodiments 1 to 4, since, for example, in a Windows (registered trademark) computer, etc., if the correct password is entered, even when the computer body 1100 is locked and the display interface of the computer body 1100 is in the inaccessible state, the computer body 1100 changes to and renders the state in which the usual access to the display interface, a legitimate user of such computer body 110 can continue to work.

### Embodiment 6

### <Outline>

Embodiment 6 is a modification of Embodiment 5 and has a feature in the point that an inactivation unit is provided for inactivating functions when the accessible status information is fixed to the accessible status.

### <Configurations>

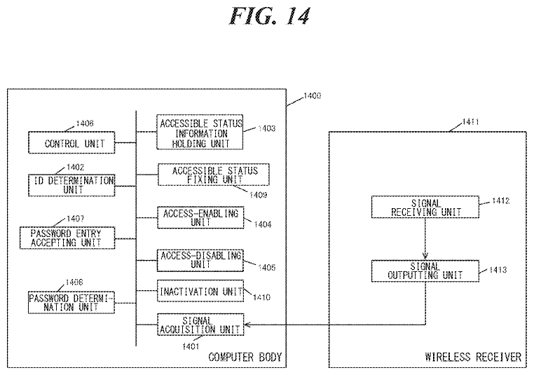

As shown in FIG. 14, the computer lock system according to Embodiment 6 comprises the computer body 1400 and the wireless receiver 1411. The wireless receiver 1411 comprises the wireless signal receiving unit 1412 and the received signal outputting unit 1413. The computer body 1400 comprises: the received signal acquisition unit 1401, the ID determination unit 1402, the accessible status information holding unit 1403, the access-enabling unit 1004, the access-disabling unit 1405, the control unit 1406, the password entry accepting unit 1407, the password determination unit 1408 and the accessible status fixing unit 1409, and further comprises an inactivation unit 1410.

### <Inactivation Unit>

When the accessible status information is fixed to the accessible status by the accessible status fixing unit 1409, the inactivation unit 1410 inactivate the functions of the received signal acquisition unit 1401, the ID determination unit 1402 and the access-disabling unit 1405 of the computer body 1400 in order to prevent the display interface of the computer body 1400 from disabling the usual access to the display by means of such units. Namely, this means that the inactivation unit 1410 suspends the functions of the present computer lock system.

### <Computer Body>

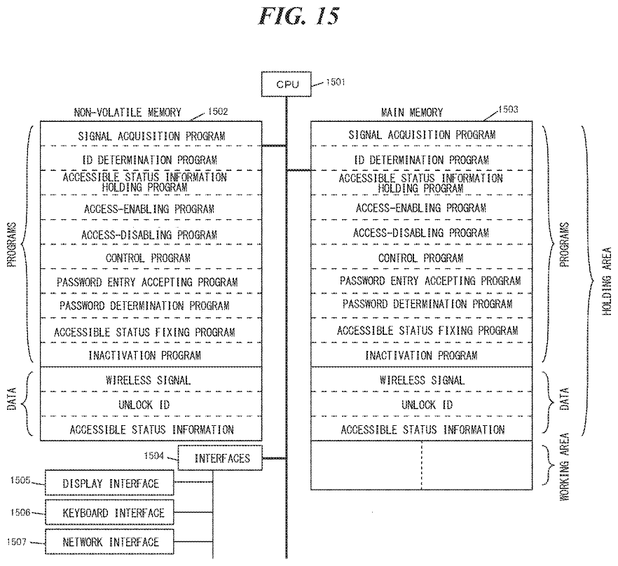

As shown in FIG. 15, the computer body 1400 is configured to include: the CPU 1501; the non-volatile memory 1502, such as an HDD, ROM, etc.; the main memory 1503, such as D-RAM, etc.; the interface 1504; the display interface 1505; the keyboard interface 1506 and the network interface 1507. The non-volatile memory 1502 stores therein programs such as an inactivation program, etc. Data includes the received wireless signal, the unlock ID, data based on the accessible status information, etc. Under control of the CPU 1501, these programs are deployed in a predetermined area in the main memory 1503 and executed based on various kinds of data. The other programs are similarly configured as those of Embodiment 5 in FIG. 12 and the description thereof will therefore be omitted.

### <Processing Flow>

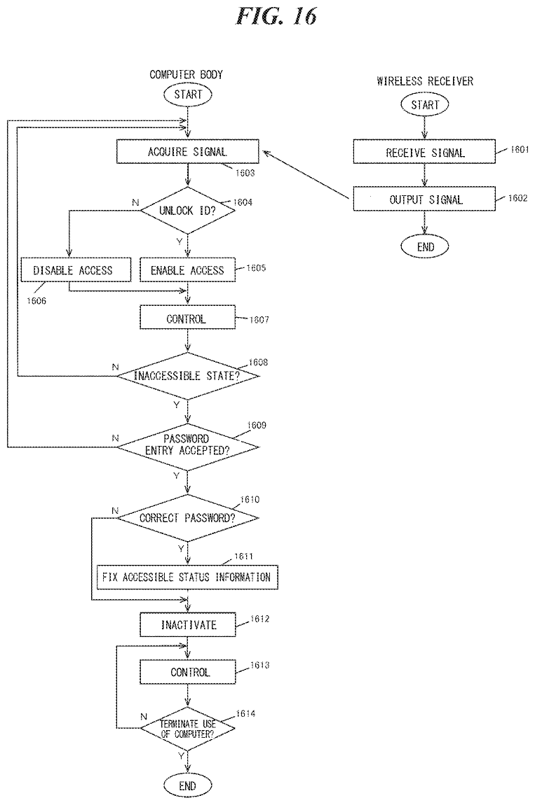

As shown in FIG. 16, in accordance with the performance of the signal receiving step 1601 and the signal outputting step 1602, the wireless signal from the wireless receiver 1411 is input into the computer body 1400 to which the wireless receiver is externally connected. The processing in the signal receiving step 1401 and the signal outputting step 1402 is similar to that in the signal receiving step 0501 and the signal outputting step 0502 of Embodiment 1 in FIG. 5 and the description thereof will therefore be omitted.

By subsequently performing the signal acquiring step 1603, the ID determining step 1604, the access-enabling step 1605, the access-disabling step 1606 and the controlling step 1607, the above-described computer body 1400 determines whether or not the acquired signal from the received signal acquisition unit 1401 contains the unlock ID (step 1604), and by performing the access-enabling step 1605 or the access-disabling step 1606, either the accessible status or the inaccessible status is held in the accessible status information holding unit 1403 as the accessible status information. The processing in the processing steps 1603 to 1607 is similar to that in the processing steps 0503 to 0507 of Embodiment 1 in FIG. 5 and the description thereof will therefore be omitted.

Under the above-described lock control by the controlling step 1607, the computer body 1400 performs a determining step (step 1608) of determining whether or not the display interface is in the inaccessible state in which the usual access to the display is disabled. If it is determined that the display interface is not in the inaccessible state (step 1608), the computer body 1400 returns to the processing in the signal acquiring step 1603.

On the other hand, if it is determined that the display interface is in the state in which the usual access to the display is disabled (i.e. the inaccessible state) (step 1608), the computer body 1400 performs, by the password entry accepting program, a password entry acceptance determining step (step 1609) of determining whether or not to accept a password entry.

In the password entry acceptance determining step 1609, if the password entry is accepted, the computer body 1400 performs, by the password determining program, a password determining step (step 1610) of determining whether or not the password is correct.

Next, if the password determining step 1610 determines that the password is correct, the computer body 1400 performs, by the accessible status information fixing program, an accessible status fixing step (step 1611) of forcibly fixing the accessible status information in the accessible status information holding unit to the accessible status.

On the other hand, if it is determined that the password entry is not accepted in the above-described password entry acceptance determining step 1609, the computer body 1400 returns to the signal acquiring step 1603.

Next, if the accessible status information is fixed to the accessible status by the accessible status fixing unit 1409, the computer body 1400 inactivates, in accordance with the execution of the inactivation program, the functions of the received signal acquisition unit 1401, the ID determination unit 1402 and the access-disabling unit 1405 of the computer body 1400 so as to prevent the display interface of the computer body 1400 from disabling the usual access to the display by means of such units (step 1612). Namely, this means that the functions of the present computer lock system are suspended.

After that, the computer body 1400 hands over the control to the lock control processing by the control program (step 1613). While the control program performs control based on the accessible status information, the control of the display interface is fixed to the accessible state since the accessible status information is fixed to the accessible status.

Following this, the computer body 1400 determines whether or not the use of the computer body 1400 by the user is terminated (step 1614). If the use is not terminated, the computer body 1400 returns to the controlling step 1613 and repeats the above-described processing. On the other hand, the computer body 1400 determines that the use of the computer body 1400 by the user is terminated (step 1614), for example, when the computer is turned off, the computer lock system is terminated. However, when the computer body 1400 is turned on again to reboot the same after it has been turned off, if may be inconvenient if the computer lock system is activated again, and it is therefore preferable for the inactivation state and the fixation of the accessible status information to be reproduced even after the rebooting.

### Embodiment 7

### <Outline>

Embodiment 7 is a modification of Embodiments 1 to 6 and has a feature in the points that the computer body and the wireless receiver externally connected to the computer body are connected to each other via a USB cable and the wireless receiver is power-fed from the computer body.

### <Configurations>

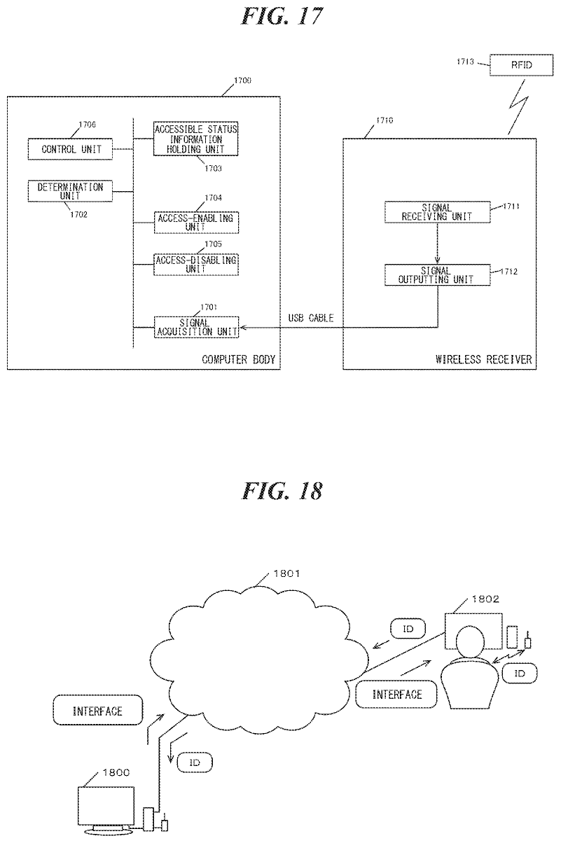

As shown in FIG. 17, the computer lock system according to Embodiment 7 is implemented by the computer body 1700 and the wireless receiver 1710. The wireless receiver 1710 comprises the wireless signal receiving unit 1711 and the received signal outputting unit 1713. The computer body 1700 comprises the received signal acquisition unit 1701, the ID determination unit 1702, the accessible status information holding unit 1703, the access-enabling unit 1704, the access-disabling unit 1705 and the control unit 1706. The computer body 1700 and the wireless receiver 1710 are externally connected to each other via a USB cable (an interface cable).

### <Power Supplying Through USB Cable Connection>

The computer body 1700 and the wireless receiver 1710 are connected to each other via a USB cable. The received signal outputting unit 1712 of the wireless receiver 1710 and the received signal acquisition unit 1701 of the computer body 1700 exchange signals by this USB cable and the wireless receiver 1710 is power-fed through this USB cable from the computer body 1700.

The received signal acquisition unit 1701 of the computer body 1700 and the received signal outputting unit 1712 of the wireless receiver 1710 are both provided with a USB interface circuit with a USB connector (not shown) and they can perform device recognition through Plug-and-Play upon connection of the USB cable. Namely, the received signal acquisition unit 1701 may acquire its own ID information, the antenna signal, etc. from the received signal outputting unit 1712 of the wireless receiver 1710. Any USB connectors, such as a USB Type-A, Type-B, Type-C, mini-B, micro-B, etc., may be used. USB interfaces, such as USB 2.0, USB 3.0, USB 3.1 interfaces, etc., may be used. A power supplying capacity of: 5 V, 500 mA for USB 2.0; 5 V, 900 mA for USB 3.0; and 5 V, 1000 mA for USB 3.1 may be achieved. In case of performing USB power supply, the amount of power used varies depending on the distance of the effective communication range of the wireless receiver 1710, and the USB interface may therefore be selected in accordance with the required amount of power. When the computer body 1700 is a compact tablet computer, etc., generally, a USB cable for a micro-B connector may be used as the connector is small. When the desired amount of power cannot be obtained from the USB interface of the computer body 1700, the computer body 1700 may be connected to the AC power through an AC power adapter, instead of driving the computer body 1700 via batteries, to supply power from the received signal acquisition unit 1701. The other configurations are similar to those of Embodiment 1 in FIG. 2 and the description thereof will therefore be omitted.

### <Computer Body>

The configurations of the computer body 1700 are similar to those of Embodiment 1 shown in FIG. 4 and the description thereof will therefore be omitted.

### <Processing Flow>

The processing flow in the wireless receiver 1710 and the computer body 1700 is similar to that of Embodiment 1 in FIG. 5 and the description thereof will therefore be omitted.

As described above, according to Embodiment 7, in addition to the advantages of Embodiments 1 to 6, since the computer body 1700 and the wireless receiver 1710 are connected to each other by a USB cable and the wireless receiver 1710 is the power-fed from the computer body 1700, a separate power supply for the wireless receiver 1710 may be dispensed with.

### Embodiment 8

### <Outline>

Embodiment 8 is a modification of Embodiments 1 to 7 and has a feature in the point that the wireless signal receiving unit of the wireless receiver is configured to receive signals from an RFID device without a power supply.

### <Configurations>

As shown in FIG. 17, the computer lock system according to Embodiment 8 is implemented by the computer body 1700 and the wireless receiver 1710. The wireless receiver 1710 comprises the wireless signal receiving unit 1711 and the received signal outputting unit 1712. The wireless signal receiving unit 1711 is configured to receive signals from an RFID device 1713 without a power supply. The computer body 1700 comprises the received signal acquisition unit 1701, the ID determination unit 1702, the accessible status information holding unit 1703, the access-enabling unit 1704, the access-disabling unit 1705 and the control unit 1706.

### <Wireless Receiver>

The wireless signal receiving unit 1711 of the wireless receiver 1710 is configured to receive signals from the RFID device 1713 without a power supply. The RFID device 1713 without a power supply may be in any form. For example, the RFID device 1713 without a power supply may be a card type for employees or may be a tag type. The effective communication range between the RFID device 1713 without a power supply and the wireless receiver 1710 is set to, for example, approximately one meter, thereby crosstalk with other wireless receivers 1710 may be prevented even if a plurality of computer bodies 1700 are installed next to each other. It should be noted that the receiving antenna of the wireless receiver 1710 is preferably an antenna with directionality. The receiving antenna is preferably directed toward the seat of the user operating the computer body 1700. The other configurations are similar to those of Embodiment 1 in FIG. 2 and the description thereof will therefore be omitted.

### <Computer Body>

The configurations of the computer body 1700 are similar to those of Embodiment 1 shown in FIG. 4 and the description thereof will therefore be omitted.

### <Processing Flow>

The processing flow in the wireless receiver 1710 and the computer body 1700 is similar to that of Embodiment 1 in FIG. 5 and a detailed description thereof will therefore be omitted, and the characteristic processing according to Embodiment 8 will be described. For example, a user wears a card-type RFID device without a power supply, like a card-type employee ID card, around his/her neck or the user places a tag-type wireless compact RFID device without a power supply in a pocket of his/her clothing. The computer body 1700 is automatically locked when the user leaves his/her seat partway through working on the computer body 1700 and goes out of the effective communication range of the wireless receiver 1710. The computer body 1700 is then automatically unlocked when the user approaches or returns to his/her seat; namely, when the user enters the effective communication range. This effective communication range is preferably a range where the distance from the computer body 1700 to which the wireless receiver 1710 is externally connected is, for example, approximately one meter.

As described above, according to Embodiment 8, in addition to the advantages of Embodiments 1 to 7, if, for example, a user wears a card-type RFID device without a power supply, like a card-type employee ID card, around his/her neck or the user places a tag-type RFID device without a power supply in a pocket of his/her clothing, the computer body 1700 is automatically locked when the user goes out of the effective communication range of the wireless receiver 1710 connected to the computer body 1700. The computer body 1700 is then automatically unlocked when the user approaches his/her seat where the locked computer body 1700 is located and enters the effective communication range. For example, the locking and unlocking are achieved in the range where the distance between the user (i.e. the RFID device) and the computer body 1700 (i.e. the wireless receiver 1710) is approximately one meter.

### Embodiment 9

### <Outline>

Embodiment 9 is a modification of any of Embodiments 1 to 8 and has a feature in the point that a network communication function is utilized.

Specifically, as shown in FIG. 18, a computer system 1800 configured to include the display, the computer body and the wireless receiver externally connected to the computer body is communicably connected to a computer system 1802 having a configuration similar to that of the computer system 1800 via a network (including a wired LAN, a wireless LAN, a mobile network, a cloud network, the Internet and broadband, etc.) 1801.

### <Configurations>

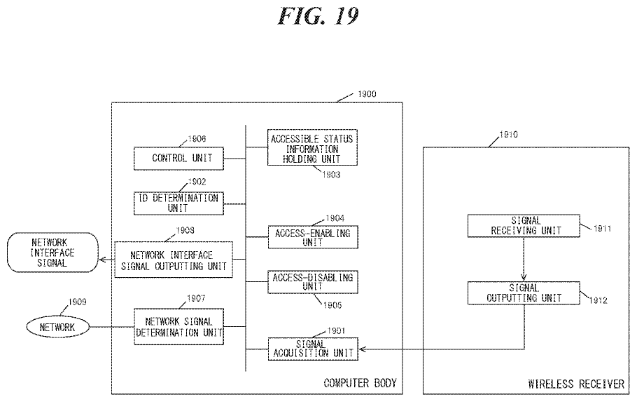

As shown in FIG. 19, the computer lock system according to Embodiment 9 is implemented by the computer body 1900 and the wireless receiver 1910. The wireless receiver 1910 comprises the wireless signal receiving unit 1911 and the received signal outputting unit 1913. The computer body 1900 comprises the received signal acquisition unit 1901, the ID determination unit 1902, the accessible status information holding unit 1903, the access-enabling unit 1904, the access-disabling unit 1905 and the control unit 1906, and further comprises a network signal determination unit 1907 and a network interface signal outputting unit 1908.

### <Network Signal Determination Unit>

The network signal determination unit 1907 determines, in an intermittent manner, whether or not the acquired signal acquired by the received signal acquisition unit 1913 of another computer system (i.e. the computer system 1802 on the right-hand side in FIG. 18) is contained in the signals received via the network 1909. The interval of the intermittent determination operation is usually set to any time between a few seconds and a few dozen seconds. Embodiment 9 achieves a function of a remote desktop computer in which, when the network signal determination unit 1907 determines that the authentic unlock ID is sent, via the network 1909, from the another computer system connected via the network 1909 to the computer body 1900 by means of the acquired signal, the computer body 1900 performs control such that the usual access to the display interface of the computer body 1900 is enabled even when the computer body 1900 has been locked. Namely, the computer body 1900 may transmit the acquired signal to other computer bodies connected via the network 1909.

### <Network Interface Signal Outputting Unit>

If the network signal determination unit 1907 and the ID determination unit determine that the unlock ID is contained in the acquired signal sent via the network 1909, the network interface signal outputting unit 1908 transmits to the another computer system (see the left-hand side in FIG. 18), via the network, an interface signal indicating that the interface(s) of the computer body 1900 is(are) in the usual accessible state. The usual access to the display interface by the another computer system that received the interface signal via the network (i.e. the network interface signal) is now enabled, and thus a remote desktop computer is achieved. On the other hand, if the unlock ID is not contained in the acquired signal, the locked state is continued if the computer body 1900 has been locked.

### <Computer Body>

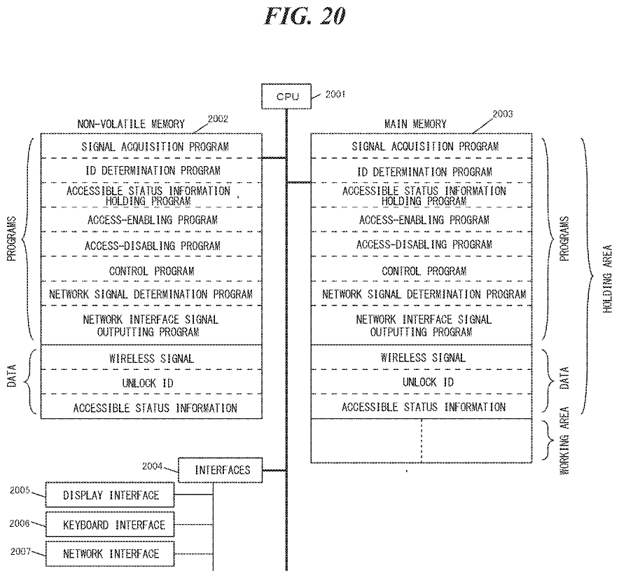

As shown in FIG. 20, the computer body 1900 is configured to include: the CPU 2001; the non-volatile memory 2002, such as an HDD, ROM, etc.; the main memory 2003, such as D-RAM, etc.; the interface 2004; the display interface 2005; the keyboard interface 2006 and the network interface 2007. The non-volatile memory 2002 stores therein programs, such as a network signal determination program, a network interface signal outputting program, etc. Data includes the received wireless signal, the unlock ID, data based on the accessible status information, etc. Under control of the CPU 2001, these programs are deployed in a predetermined area in the main memory 2003 and executed based on various kinds of data. The other programs are similar to those of Embodiment 1 shown in FIG. 4 and the description thereof will therefore be omitted.

### <Processing Flow>

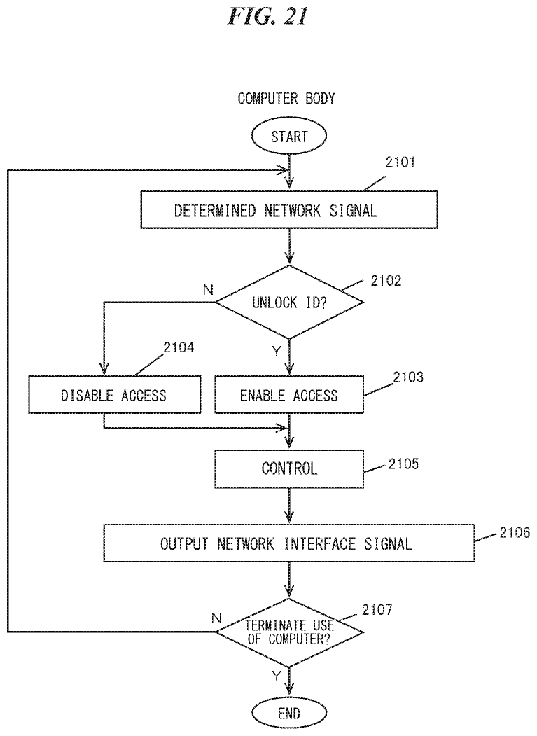

As shown in FIG. 21, the above-described computer body 1900 performs, in accordance with the execution of the network signal determination program, a network signal determination step (step 2101) of determining, in an intermittent manner, whether or not the acquired signal acquired by the received signal acquisition unit 1913 of another computer system is contained in the signal received via the network.

Next, in accordance with the execution of the ID determination program, the computer body 1900 performs a determining step (step 2102) of determining, in an intermittent manner, whether or not the unlock ID, which is an ID for enabling the usual access to the display interface, is contained in the acquired signal.

After this, if the ID determining step 2102 determines that a valid unlock ID is contained, in accordance with the execution of the access-enabling program, the computer body 1900 performs the access-enabling step (step 2103) of changing the accessible status information held in the accessible status information holding unit 1903 to the accessible status for enabling the usual access to the display interface.

On the other hand, when the ID determining step 2102 determines that a valid unlock ID is not contained, the computer body 1900 performs the access-disabling step (step 2104) of changing the accessible status information to the inaccessible status for causing the display interface to disable the usual access to the display.

Next, in accordance with the execution of the control program, the computer body 1900 performs the controlling step (step 2105) of controlling the display interface based on the accessible status held in the accessible status information holding unit 1903.

If the network signal determination step 2101 determines that the unlock ID is contained, the computer body 1900 performs the network interface signal outputting step (step 2106) of sending, to the another computer system connected via the network, an interface signal that indicates that the display interface is in the usual accessible state.

If the use of the computer body 1900 by the user is not terminated (step 2107, N), the computer body 1900 returns to the network signal determination step 2101 and the above-described processing is repeated. On the other hand, if the use of the computer body 1900 is terminated (step 2107, Y), for example, when the computer body 1900 is turned off, the processing is terminated.

If the computer is turned on again, the computer lock system is activated, and the locking and unlocking are automatically controlled based on the unlock ID assigned to the computer body 1900 and the user status information without requiring any user operations.

As described above, according to Embodiment 9, in addition to the advantages of Embodiments 1 to 8, the locking and unlocking control by means of remote connection of the computer body 1900 via the network is achieved.

As described above, according to Embodiments 1 to 9, in a computer lock system comprising a computer body and a wireless receiver externally connected to the computer body, security can be maintained even when the wireless receiver is detached.

1. A computer lock system comprising:
a computer body and;
a wireless receiver externally connected to the computer body, wherein
the wireless receiver includes:
a wireless signal receiving unit that receives a wireless signal that may include noise or be in a no-signal state; and
a received signal outputting unit that outputs the received wireless signal to the computer body, and wherein
the computer body includes:
a received signal acquisition unit that acquires the signal output from the received signal outputting unit;
an ID determination unit that determines, in an intermittent manner, whether an unlock ID, which is an ID for enabling usual access to a display interface of the computer body, is contained in an acquired signal from the received signal acquisition unit;
an accessible status information holding unit that holds accessible status information that indicates whether or not the usual access to the display interface of the computer body is enabled, the indication being determined based on the acquired signal;
an access-enabling unit that changes, when the ID determination unit determines that a valid unlock ID is contained, the accessible status information held in the accessible status information holding unit to an accessible status for enabling the usual access to the display interface of the computer body;
an access-disabling unit that changes, when the ID determination unit determines that a valid unlock ID is not contained, the accessible status information held in the accessible status information holding unit to an inaccessible status for causing the display interface of the computer body to disable the usual access to a display; and
a control unit that controls the display interface based on the accessible status information held in the accessible status information holding unit.

2. The computer lock system according to claim 1, wherein
the received signal acquisition unit, the ID determination unit, the accessible status information holding unit, the access-enabling unit, the access-disabling unit and the control unit of the computer body are configured to be operative whenever the computer body is in operation.

3. The computer lock system according to claim 1, wherein
the wireless signal receiving unit and the received signal outputting unit are configured to be operative whenever the wireless receiver is externally connected to the computer body that is in operation.

4. The computer lock system according to claim 1, wherein
the computer body further includes:
a screen saver unit that displays and outputs a screen saver screen when no input is made from an interface for a predetermined period of time; and
a conflict coordinating unit that gives priority to an operation of the control unit when the operation of the control unit and an operation of the screen saver unit conflict with each other.

5. The computer lock system according to claim 1, further including:
a password entry accepting unit that accepts an entry of a password, when the ID determination unit determines that the valid unlock ID is not contained and when the display interface of the computer body is in a state in which the usual access to the display is disabled;
a password determination unit that determines whether or not the password is correct; and
an accessible status fixing unit that forcibly fixes the accessible status information in the accessible status information holding unit to the accessible status when the password determination unit determines that the password is correct.

6. The computer lock system according to claim 5, further including:
an inactivation unit that inactivates, when the accessible status information is fixed to the accessible status by the accessible status fixing unit, functions in order to prevent the display interface of the computer body from disabling the usual access to the display by means of the received signal acquisition unit, the ID determination unit and the access-disabling unit.

7. The computer lock system according to claim 1, wherein
the computer body and the wireless receiver are connected to each other via a USB cable, the received signal outputting unit and the received signal acquisition unit of the computer body exchange signals by the USB cable, and the wireless receiver is power-fed through the USB cable.

8. The computer lock system according to claim 1, wherein
the wireless signal receiving unit is configured to receive a signal from an RFID device without a power supply.

9. The computer lock system according to claim 1, wherein
the computer body includes:
a network signal determination unit that receives, via a network, an acquired signal of a signal acquisition unit of one of other computer bodies connected via the network and that determines whether or not the unlock ID is contained in the received acquired signal; and
a network interface signal outputting unit that transmits an interface signal that indicates that the interface of the computer body is in the usual accessible state to the one of other computer bodies via the network, when the network signal determination unit determines that the unlock ID is contained.

10. A method of operating a computer lock system which includes a computer body and a wireless receiver connected to the computer body, comprising:
performing, by the wireless receiver:
a wireless signal receiving step of receiving a wireless signal that may include noise or be in a no-signal state; and
a signal outputting step of outputting the received wireless signal to the computer body; and
performing, by the computer body:
a signal acquisition step of acquiring the signal output from a signal outputting unit;
an ID determination step of determining whether or not an unlock ID, which is an ID for enabling usual access to a display interface of the computer body, is contained in an acquired signal from the signal acquisition step;
an accessible status information holding step of holding accessible status information that indicates whether or not the usual access to the display interface of the computer body is enabled, the indication being determined based on the acquired signal;
an access-enabling step of changing, when the ID determination step determines that a valid unlock ID is contained, the accessible status information held in an accessible status information holding step to an accessible status for enabling the usual access to the display interface of the computer body;
an access-disabling step of changing, when the ID determination step determines that a valid unlock ID is not contained, the accessible status information held in the accessible status information holding step to an inaccessible status for causing the display interface of the computer body to disable the usual access to a display; and
a controlling step of controlling the display interface based on the accessible status information held in the accessible status information holding step.

11. A computer readable recording medium having a non-transitory computer program recorded thereon and that runs on a computer body to which a wireless received is connected, wherein
the wireless receiver comprises:
a signal receiving unit that receives a wireless signal that may include noise or be in a no-signal state; and
a signal outputting unit that outputs the received signal to the computer body, and wherein
the computer program causes the computer body to perform:
a signal acquisition step of acquiring the signal output from the signal outputting unit;
an ID determination step of determining whether or not an unlock ID, which is an ID for enabling usual access to a display interface of the computer body, is contained in an acquired signal from the signal acquisition step;
an accessible status information holding step of holding accessible status information that indicates whether or not the usual access to the display interface of the computer body is enabled, the indication being determined based on the acquired signal;
an access-enabling step of changing, when the ID determination step determines that a valid unlock ID is contained, the accessible status information held in the accessible status information holding step to an accessible status for enabling the usual access to the display interface of the computer body;
an access-disabling step of changing, when the ID determination step determines that a valid unlock ID is not contained, the accessible status information held in the accessible status information holding step to an inaccessible status for causing the display interface of the computer body to disable the usual access to a display; and
a controlling step of controlling the display interface based on the accessible status information held in the accessible status information holding step.
